(19) United States
(12) Patent Application Publication
(10) Pub. No.: US 2007/0011170 A1
(43) Pub. Date: Jan. 11, 2007

(54) Systems and methods for granting access to data on a website

(76) Inventor: Keith Alan Hackworth, Buford, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 11/177,262

(22) Filed: Jul. 8, 2005

(51) Int. Cl. G06F 17/30

(52) U.S. Cl. 707/10

(57) ABSTRACT

Included in this disclosure is a method for granting access to data on a website. The method may include receiving first data, at least a portion of the first data relating to information about a user machine and communicating second data, at least a portion of the second data relating to a first web page on a website, the first web page including an image. Also included in the method are receiving third data, at least a portion of the third data relating to whether the user machine requested an image on the first web page, determining from the third data whether the user machine requested an image on the first web page; and performing at least one preventative measure in response to determining that the user machine did not request an image on the first web page.

### TECHNICAL FIELD

The present disclosure relates to Internet management. More specifically, the present disclosure relates to systems and methods for granting access to data on a website.

### BACKGROUND

The Internet provides a medium for communicating data. Generally speaking, the Internet includes an interconnecting system of networks that connects computers. Among other things, the Internet allows users to shop, pay bills, and view news, radio and television. However, this has not always been the case. As the Internet was first emerging, websites, which may be defined generally as a collection of interconnected web pages on the Internet, simply displayed text and possibly images and with no significant interaction with the user. However, as processing speeds, storage capabilities and bandwidth increased, and overall network and computer architecture improved,-websites were able to perform many functions that were previously impossible. Websites had gained the ability to include multiple web pages that include images, video, the ability for a user to purchase goods and services, and other innovative applications not previously available.

With this development of Internet and web page design, web hosts, which can be a person or company that makes a website available on the Internet, began improving their websites to attract more users. One advancement in website design was the ability for a user to search large amounts of data. This data can take many forms including, but not limited to telephone listings, address listings, email listings, statistics, credit card numbers, bank account numbers, social security numbers, and medical history data. While the web host may wish to allow certain users to view the data, a web host generally wants to prevent users to profiting from this data. Additionally, in some embodiments web hosts are storing customer or client information and do not want those with deceitful intentions to acquire such data. For at least this reason, many web hosts have taken measures to prevent “data mining” and other forms of data collection. Data mining occurs when a user writes a computer program or script that allows a computer to automatically access a website and retrieve data from that website. Once the user has acquired the data, he or she may sell the data to others, who may use the information for advertising or other purposes. While the web host may encourage Internet users to view the website, the web host typically does not want others profiting from information that the web host invested time and money to compile. Additionally, the information can relate to customers or clients of the web host, who most likely do not want this information disseminated to others. One nonlimiting example can occur with telephone listings. A web host of a telephone listing website may spend large sums of money and expend massive amounts of energy to compile telephone listings for a city, state, country, etc. These telephone listings are generally intended for website users who wish to retrieve data relating to particular entries. The web host, however generally does not desire that this information be available to users (such as data miners and spammers) who scrape, scan, or steal this information.

To battle data mining and other forms of undesired data collection, web hosts have taken various measures. One such measure is to insert false information into the listings. With telephone listings, the web host can include fake telephone numbers that no user could confuse with a real listing. The web host could then identify data miners by recording IP addresses of all users on the website, and determining which IP addresses accessed the false listings. Similarly, the false listing can be real data that the web host controls. Instead of monitoring user IP addresses the user can simply monitor the false data. As a nonlimiting example, if the website information includes email address listings, the web host can include at least one false email address that the web host controls. If the email address receives unwanted email, the web host can determine that the sender of the email acquired the information through data mining tactics, and prevent the sender from future access to the website.

This method however, can be problematic. Inserting false information could possibly deceive legitimate users of the website. These users may believe that this false information is valid, or access this information by mistake. An innocent user may be prohibited from future use of the website.

An alternate solution that web hosts impose is displaying an image of a series of wavy characters with lines or patterns overlayed. The user is given a prompt to enter the characters seen on the display. While such a measure may prevent data mines and other scripts from accessing the website, this procedure can be cumbersome to the human user, especially if frequently repeated.

Another solution web hosts have implemented includes integrating into the website a script that records user IP addresses, and counts the number of searches one user makes over a certain amount of time. If any user completes more than the predetermined number of searches, that user may be prohibited from future use of the website. While this method of data protection can be effective in reducing data mining on a website, such a method can consume large amounts of networking resources, and can accidentally exclude legitimate users from accessing the website.

Thus, a heretofore unaddressed need exists in the industry to address the aforementioned deficiencies and inadequacies.

### SUMMARY

Included in this disclosure are systems for granting access to data on a website. At least one embodiment includes a database and a server coupled to the database, the server including first logic. The first logic is configured for receiving first data, where at least a portion of the first data relates to information about a user machine. The first logic is also configured for effecting communication of second data, where at least a portion of the second data relates to a first web page on a website. The system also includes second logic configured for receiving third data, where at least a portion of the third data relates to whether the user machine requested an image on the first web page. The second logic is also configured for determining whether the user machine requested an image on the first page. The second logic is also configured for performing at least one preventative measure in response to determining that the user did not request an image on the first page.

Also included in this disclosure are methods for granting access to data on a website. At least one embodiment includes receiving first data, at least a portion of the first data relating to information about a user machine; effecting communication of second data, at least a portion of the second data relating to a first web page on a website, the first web page including an image; receiving third data, at least a portion of the third data relating to whether the user machine requested an image on the first web page; determining from the third data whether the user machine requested an image on the first web page; performing at least one preventative measure in response and to determining that the user machine did not request an image on the first web page.

This disclosure also includes computer readable mediums for granting access to data on a website. At least one embodiment includes first logic configured for instructing a programmable device to receive first data, where at least a portion of the first data relates to information about a user machine. This embodiment also includes second logic configured for instructing a programmable device to communicate second data, where at least a portion of the second data relates to a first web page on a website, the first web page including an image. This embodiment additionally includes third logic configured for instructing a programmable device to receive third data, where at least a portion of the third data relates to whether the user machine requested an image on the first web page. This embodiment also includes fourth logic configured for instructing a programmable device to determine from the third data whether the user machine requested an image on the first web page. Additionally, this embodiment includes fifth logic configured for instructing a programmable device to perform at least one preventative measure in response to determining that the user machine did not request an image on the first web page.

Other systems, methods, features and/or advantages will be or may become apparent to one with skill in the art upon examination of the following drawings and detailed description. It is intended that all such additional systems, methods, features and/or advantages be included within the scope of the present invention and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a functional block diagram illustrating various components that may be utilized when a user requests access to a website.

FIG. 2 is an abstraction view representing various web pages available through a website that may be implemented by the components of FIG. 1.

FIG. 3 is a flow chart illustrating possible steps a user may take when accessing a website implemented by the components of FIG. 1.

FIG. 4 is a flow chart illustrating possible steps a data miner or other undesirable data collector may take when gathering data from the website of FIG. 2.

FIG. 5 is an example screen shot of a home page that may be displayed on the website of FIG. 2.

FIG. 6 is an example screen shot of a search page that may be displayed on the website of FIG. 2.

FIG. 7 is an example screen shot of a search results page that may be displayed on the website of FIG. 2.

FIG. 8A is an example screen shot of a navigation blocked web page indicating that a user has been blocked from future searches on the website of FIG. 2.

FIG. 8B is an example screen shot of an alternate search results page on the website of FIG. 2.

FIG. 9 is a flowchart illustrating steps that can be taken for data protection on the website of FIG. 2.

FIG. 10 is a flowchart of a data protection technique for counting user searches on the website of FIG. 2.

FIG. 11 is a flowchart illustrating alternate steps that can be taken for data protection on the website of FIG. 2.

### DETAILED DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

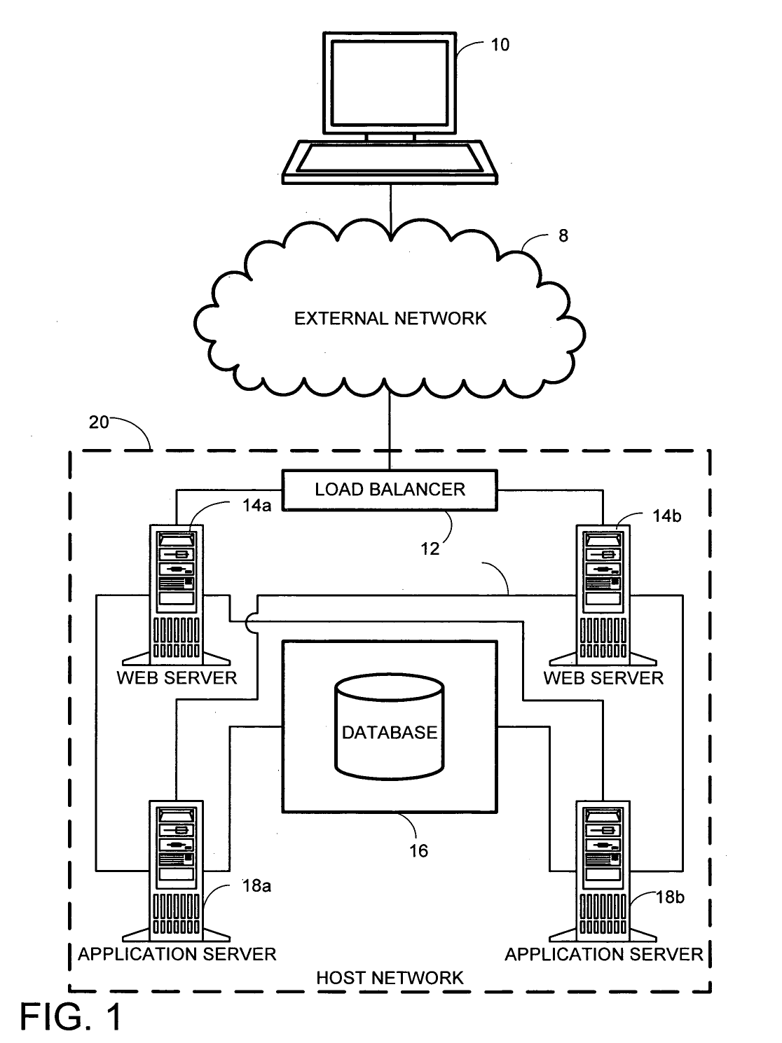

FIG. 1 is a functional block diagram illustrating various components that may be utilized when a user requests access to a website. As illustrated in FIG. 1, a user machine 10 may be coupled to an external network, such as the Internet. Similarly, a host network 20 may also be coupled to the external network 8. The host network 20 may include various components including, but not limited to one or more web servers 14a, 14b, one or more application servers 18a, 18b, one or more load balancers 12, and one or more application databases 16.

The load balancer 12 may be implemented in hardware, software, or firmware, and in some embodiments is used to increase website efficiency. As more users access a website, the web host may desire to distribute certain traffic to various portions of the host network 20. In FIG. 1; the load balancer 12 may be configured to route Internet traffic between web server 14a and web server 14b. The load balancer may route traffic according to a DNS balancing, hardware load balancing, software balancing, reverse proxying, or other means of balancing Internet traffic.

In FIG. 1, the web servers 14a, 14b are both coupled to application servers 18a, 18b. Web servers 14a, 14b may serve to communicate HTML (Hypertext Markup Language) code to the user machine 10, and may also serve various other functions, depending on the desires of the host network 20. Historically, web servers 14a, 14b were capable only of communicating HTML communications to and from the user machine 10. However, present day web servers 14a, 14b may be capable of running scripts, loading streaming video, and many other functions traditionally reserved for application servers 18a, 18b.

In FIG. 1, the application servers 18a, 18b are both coupled to the web servers 14a, 14b and the application database 16. Application servers 18a, 18b have traditionally enabled a web host to provide streaming video, and other dynamic applications that the web servers 14a, 14b where unable to handle. However, the application servers 18a, 18b may also act as a web server 14a, 14b, if the web host desires. In the exemplary embodiment of FIG. 1, both application servers 18a, 18b and web servers 14a, 14b are utilized to facilitate Internet traffic to the website.

Also included in host network 20 is an application database 16. The application database 16 is coupled to application servers 18a, 18b and may be configured to store data for access by the application servers 18a, 18b. Application database 16 may store other data utilized by the application servers 18a, 18b or data regarding a user of the website.

As discussed above, the components illustrated in FIG. 1 are merely illustrative. Any configuration for providing information to a user may also be included in this disclosure.

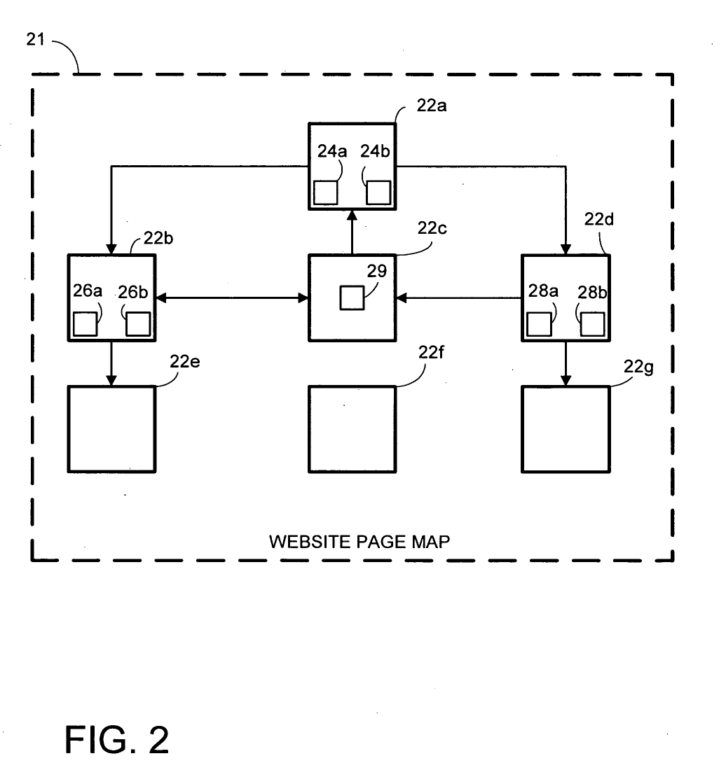

FIG. 2 is an abstraction view representing various web pages available through a website that may be implemented by the components of FIG. 1. As illustrated in FIG. 1, user machine 10 is coupled to the external network 8. Similarly, the external network 8 is also coupled to the host network 20. The host network may provide user machine 10 with a website page map 21 that includes one or more web pages. Referring to FIG. 2, a user may navigate through the website page map 21 according to a predefined arrangement of the web pages. Since each web page 22a-22g includes its own web address or URL (uniform resource locator), the user may access any of the web pages by simply inputting the appropriate URL. However, in many cases, the user will input the URL of the website home page and navigate according to the website configuration. In the exemplary embodiment of FIG. 2, the user first accesses the website at a generic home page 22a. The generic home page 22a may include data about the web host or other data depending on the website. From generic home page 22a, the user may activate a link 24a that will allow the user to view generic web page 22b. Alternatively, the user may activate link 24b to view generic web page 22d. If the user is currently viewing generic web page 22b, he or she may activate a link 26a that will allow the display of generic web page 23e. From generic web page 22b, the user also has the option of activating link 26b to view generic web page 22c. From the generic web page 22d, the user has the option of activating link 28a to view generic web page 22c, or activating link 28b to view generic web page 22g. From web page 22c, the user may activate link 29 to return to generic home page 22a.

Additionally, according to the configuration of FIG. 2, access to generic web page 22f is only available by inputting the appropriate URL. There is no navigational access to generic web page 22f. When a user wishes to view a website, he or she typically enters a website address on his or her browser. Alternatively, the user may activate a link that is displayed on the user's monitor or the user's browser may automatically display the website as the user's home page. Although FIG. 2 illustrates one embodiment of a web page configuration on a website, this is but a nonlimiting example.

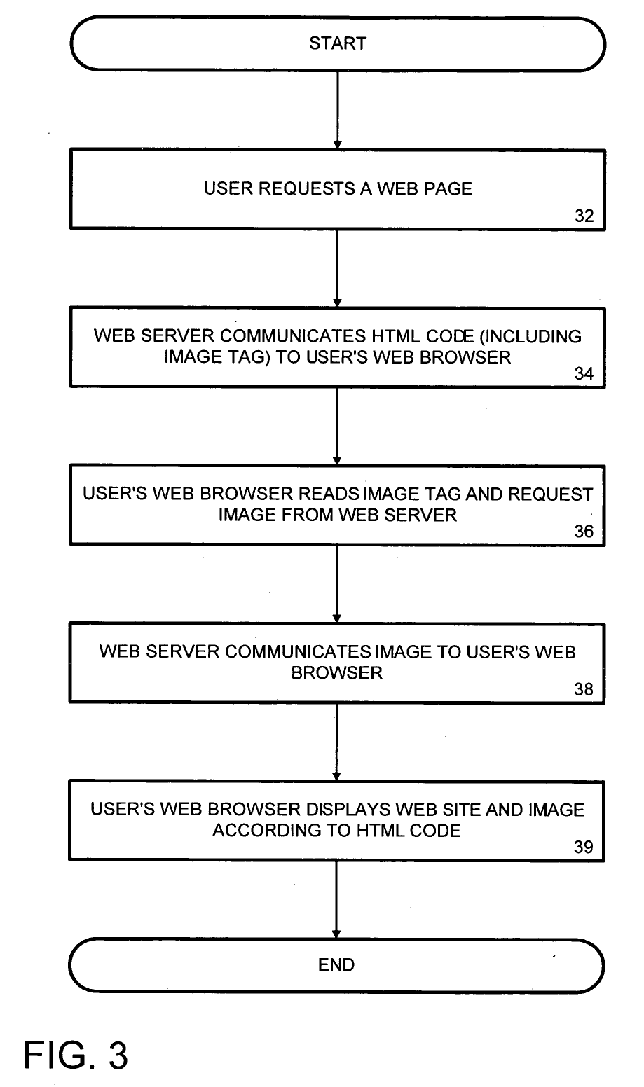

FIG. 3 is a flow chart illustrating possible steps a user may take when accessing a website implemented by the components of FIG. 1. In FIG. 3, the user requests a web page (step 32), and the web server 14a, 14b of that particular website communicates HTML code (including image tag) to the user's web browser (step 34). In some embodiments, the HTML code includes an image tag for each image on the web page. The image tag indicates to the user's browser that an image can be included in displaying the web page.

The user's web browser reads the HTML code and image tag, and requests the image from the web server 14a, 14b (step 36). The image may be stored on web server 14a, 14b, in another part of host network 20, or elsewhere. In some cases, the web server 14a, 14b (or other portion of host network 20) communicates the image to the user's web browser (step 38). Finally, the user's web browser displays the web page and image according to the HTML code (step 39).

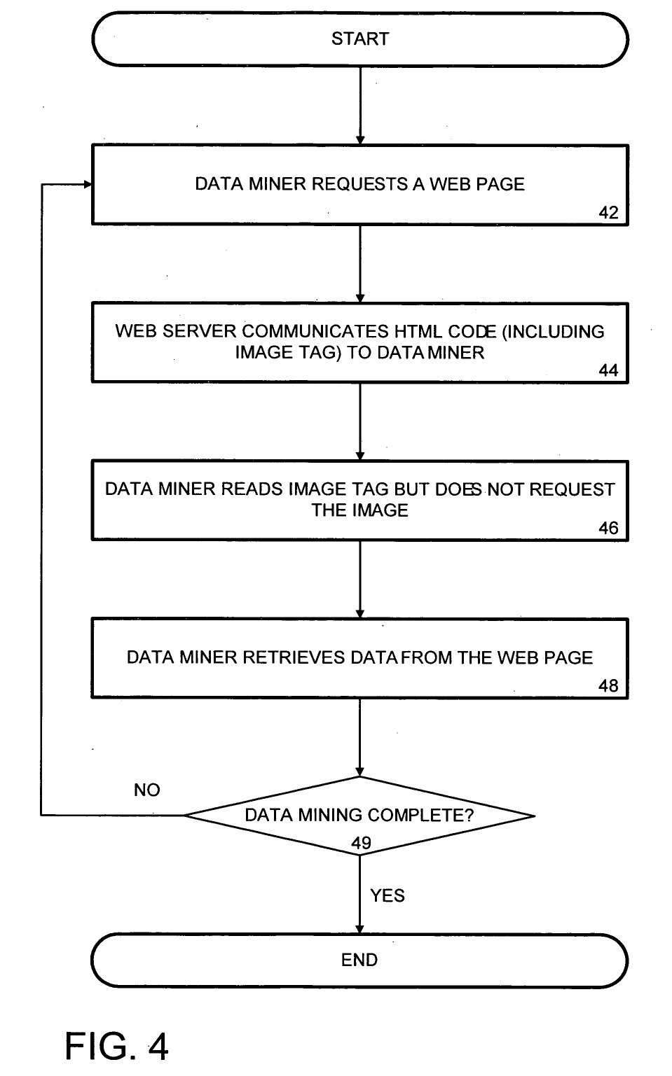

FIG. 4 is a flow chart illustrating possible steps a data miner or other undesirable data collector may currently take when gathering data from the website of FIG. 2. In FIG. 4, the data miner first requests a web page (step 42). The web server communicates the HTML code (including the image tag) to the data miner (step 44). The data miner reads the HTML code, including the image tag, but does not request the image (step 46). The data miner retrieves or downloads data from the web page (step 48). Depending on the configuration of the website, the data miner performs a check to determine if data mining is complete (step 49). If data mining is not complete, the data miner returns to the appropriate web page to search and collect additional data.

Currently, data miners access a website that includes lists of data. The data may be displayed not simply on a single web page, but can instead be accessed through various searches. As a nonlimiting example, a website may include an alphabetical list of people, where each letter is stored on a separate web page. In this situation, a data miner would perform a search for the letter “a.” When the data is gathered from this web page, the data miner would return to the search page and begin with the next letter of the alphabet. The data miner could continue until all the data is collected.

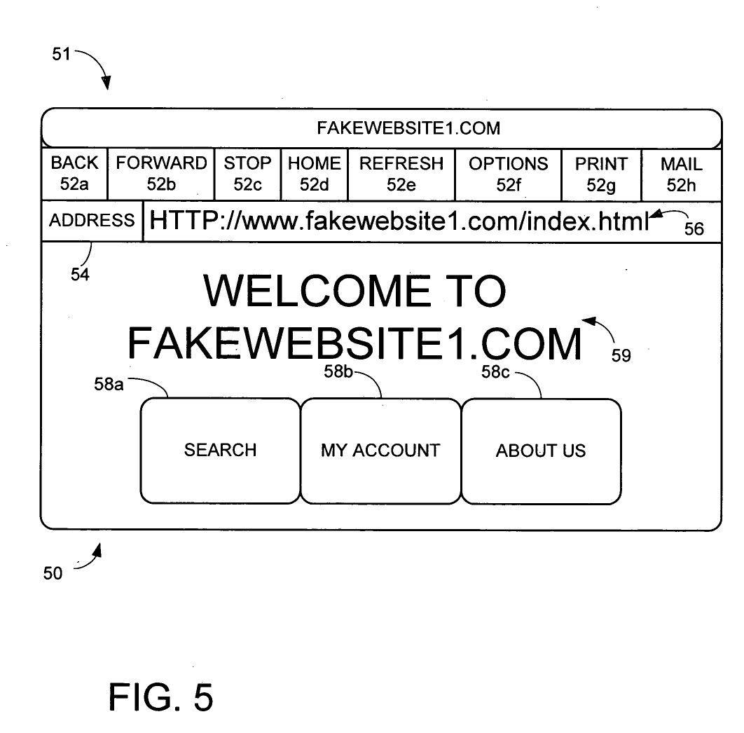

FIG. 5 is an example screen shot of a home page that may be displayed on the website of FIG. 2. As illustrated in FIG. 5, a home page 50 is displayed in browser 51. The browser includes a back button 52a, a forward button 52b, a stop button 52c, a home button 52d, a refresh button 52e, an options button 52f, a print button 52g, and a mail button 52h. Also included in the browser 51 is an address line 54, with the home page URL 56 displayed. This URL corresponds to the home page 50 being displayed. The home page 50 includes a welcome banner 59, a search button 58a, a “my account” button 58b, and an “about us” button 58c.

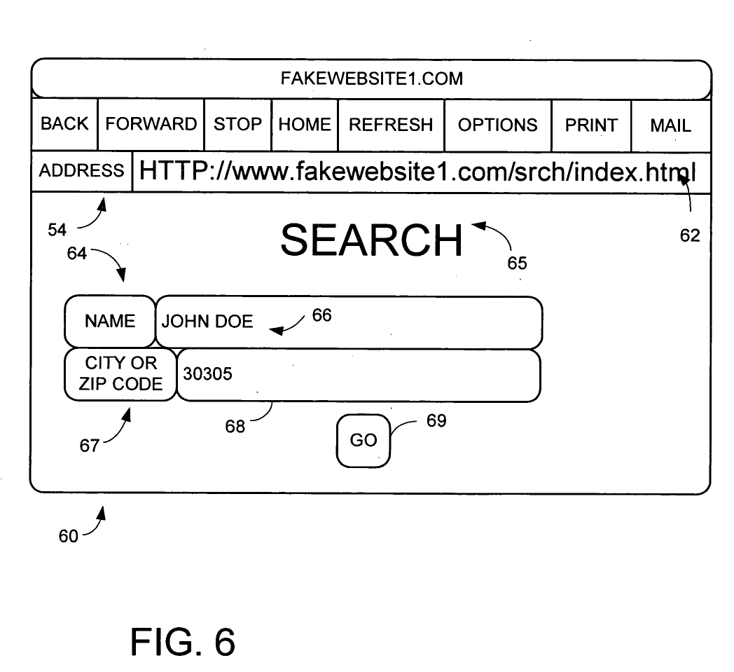

FIG. 6 is an example screen shot of a search page that may be displayed on the website of FIG. 2. As illustrated in FIG. 6, a search page 60 includes the search page URL 62 displayed in address line 54. The search page 60 also includes a name prompt 64, an entered name 66, a city or zip code prompt 67, and entered zip code 68, a “go” button 69, and a search banner 65. To perform a search, a user can enter a name, or part of a name into name prompt 64. The user can also enter a city or zip code for the name 66 into city or zip code prompt 67. This data has been entered as entered name 66 and entered zip code 68. The user can then actuate the “go” button 69 to begin the search.

As is evident to one of ordinary skill in the art, the search criteria illustrations in FIG. 6 are but a nonlimiting example. Any applicable search criteria may be used to find the desired information. FIG. 6, as well as the other drawings in the disclosure serve to explain, not to limit the scope of this disclosure.

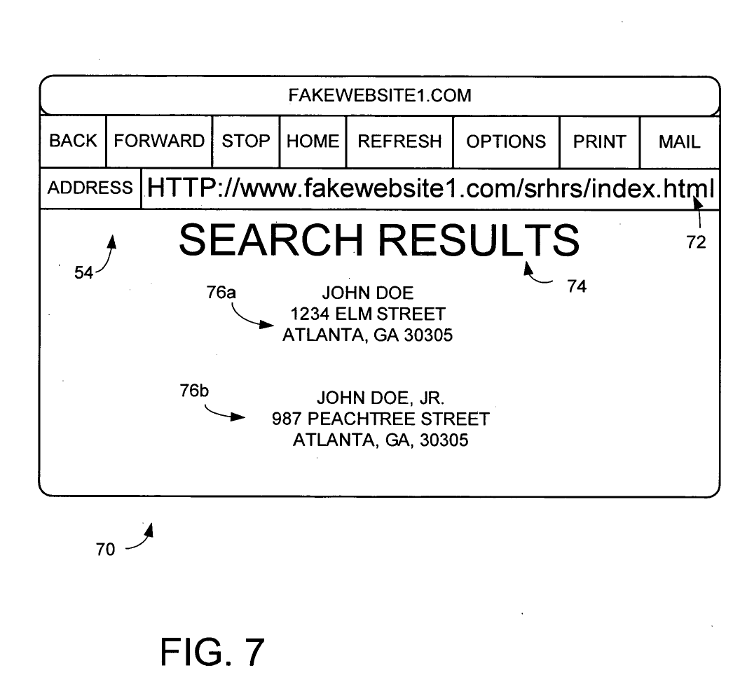

FIG. 7 is an example screen shot of a search results page 70 that may be displayed on the website of FIG. 2. The search results page 70 includes the search results URL 72 in the address line 54. Also included in the search results page 70 is first search results data 76a, which includes information about John Doe, and second search results data 76b, which includes information about John Doe, Jr. The information in the search results data 76a, 76b may be displayed in response to completing the search illustrated in FIG. 6. By inputting and searching the name John Doe with a 30305 zip code, the website may display any or all listings with corresponding data. Similarly, other search criteria may be used and included in the search page from FIG. 6. In addition, the information displayed on the search results page may be textual to allow a user versatility in using and accessing the information displayed. Also included in the search results page 70 is a search results banner 74.

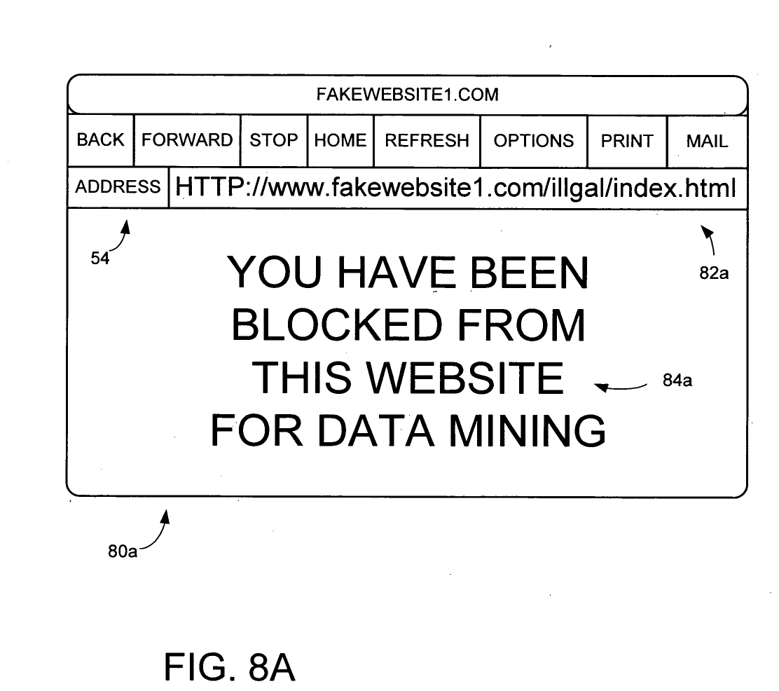

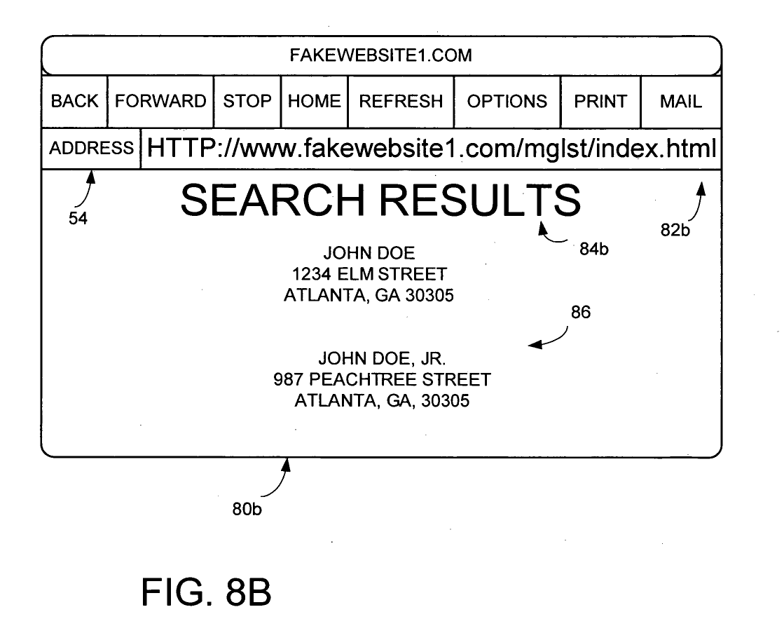

FIG. 8A is an example screen shot of a navigation blocked web page 80a indicating that a user has been blocked from future searches on the website of FIG. 2. As illustrated, address line 54 includes the illegal action URL 82a. Also included is a navigation blocked banner 84a indicating to the user that he or she is prevented from using the website. As is evident to one of ordinary skill in the art, this page is a nonlimiting example of a possible indicator of data mining. Other indicators may be implemented including, but not limited to that illustrated in FIG. 8B.

FIG. 8B is an example screen shot of an alternate search results page 80b on the website of FIG. 2. As illustrated, address line 54 includes the image list URL 82b. Also included is the search results information from FIG. 7, and a search results banner 84b. However, in the alternate search results page 80b, the information listed is displayed as one or more images, instead of the textual data of FIG. 7. The display of images prevents a data miner script from reading the information displayed on the web page, and since most scripts do not request the images, the data will never be displayed. On the other side, if a user is mistakenly labeled as a data miner, he or she will still have access to the desired data.

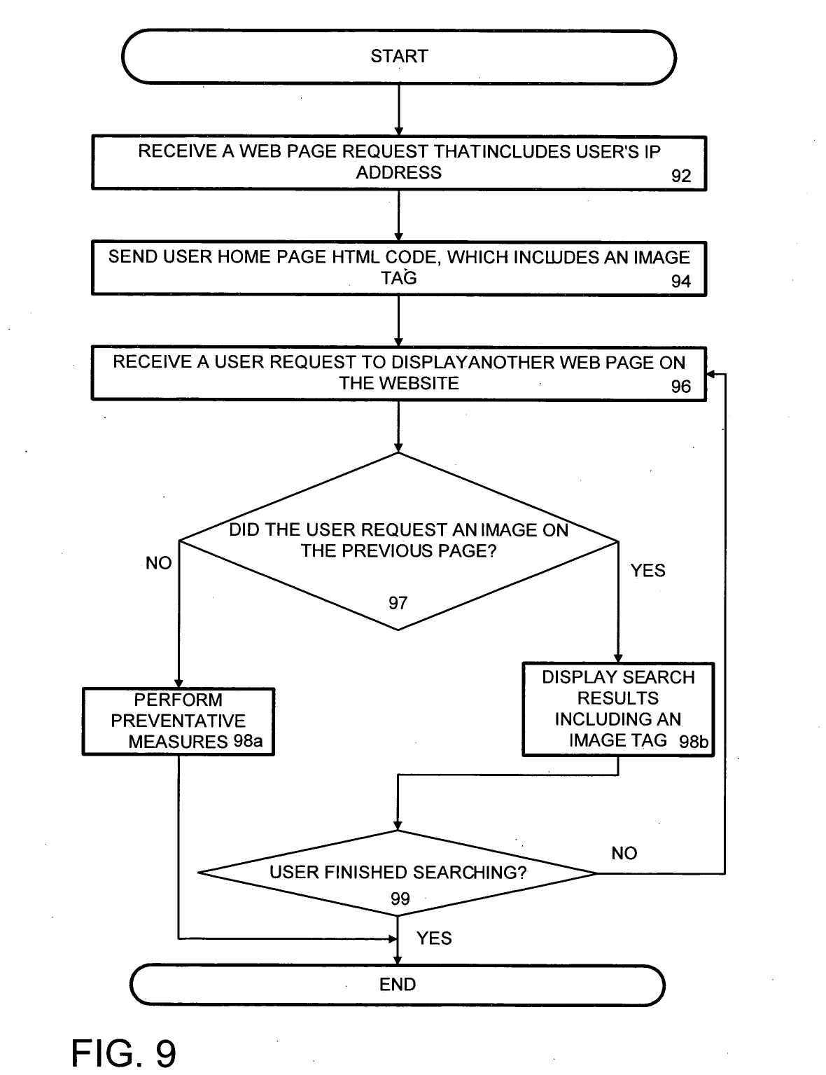

FIG. 9 is a flowchart illustrating steps that can be taken for data protection on the website of FIG. 2. The first step illustrated in FIG. 9 includes receiving a web page request that includes a user's IP address (step 92). Next, the host network 20 (FIG. 1) sends to the user HTML code relating to the home page requested, where the HTML code includes an image tag (step 94). Referring to FIG. 5, the image tag can refer to the welcome banner 59, the search button 58a, the “my account” button 58b, the “about us” button 58c, or any other image displayed on the home page 50. Similarly, the image tag may refer to an image that is not perceivable by the user, such as a one-pixel image.

The host network 20 can receive a user request to display another web page on the website (step 96). In one nonlimiting example, the user may request the display of the search page 60 from FIG. 6. The host network 20 can determine whether the user requested an image on the home page 50 (step 97). The host network 20 can search the application database 16 for data relating to the user's machine and determine whether an image was requested. If the user's browser did not request an image on the home page 50, the user is likely a data miner. As stated above, data miners typically ignore image data and focus on textual data. By not requesting an image on the home page, the user is likely a data miner. If the user does not request an image on the home page, the host network 20 can perform preventative measures such as those illustrate in FIGS. 8A, 8B (step 98a). If however, the user does request an image on the home page 50, the search results including an image tag are displayed (step 98b). If the user is not finished searching, the process returns to step 96, and the process continues. In this flowchart, for each search the user performs, a check is performed to determine whether an image was requested on the previous page.

One should note that many data miners bypass the home page and proceed directly to the search page. In this situation, the data miner will not have requested an image on the home page and will thus be subject to preventative measures of step 97.

Additionally, one should note that many Internet devices, such as mobile telephones, PDAs, Palm Pilots, etc. may include a web browser option that allows display of an web page without displaying images. The systems and methods disclosed herein appreciate such a scenario and allow for exceptions to the preventative measures discussed above based on IP address, browser type, or other criteria. Such exceptions allow users that access the Internet without displaying images to retrieve desired information while still preventing others from data mining practices.

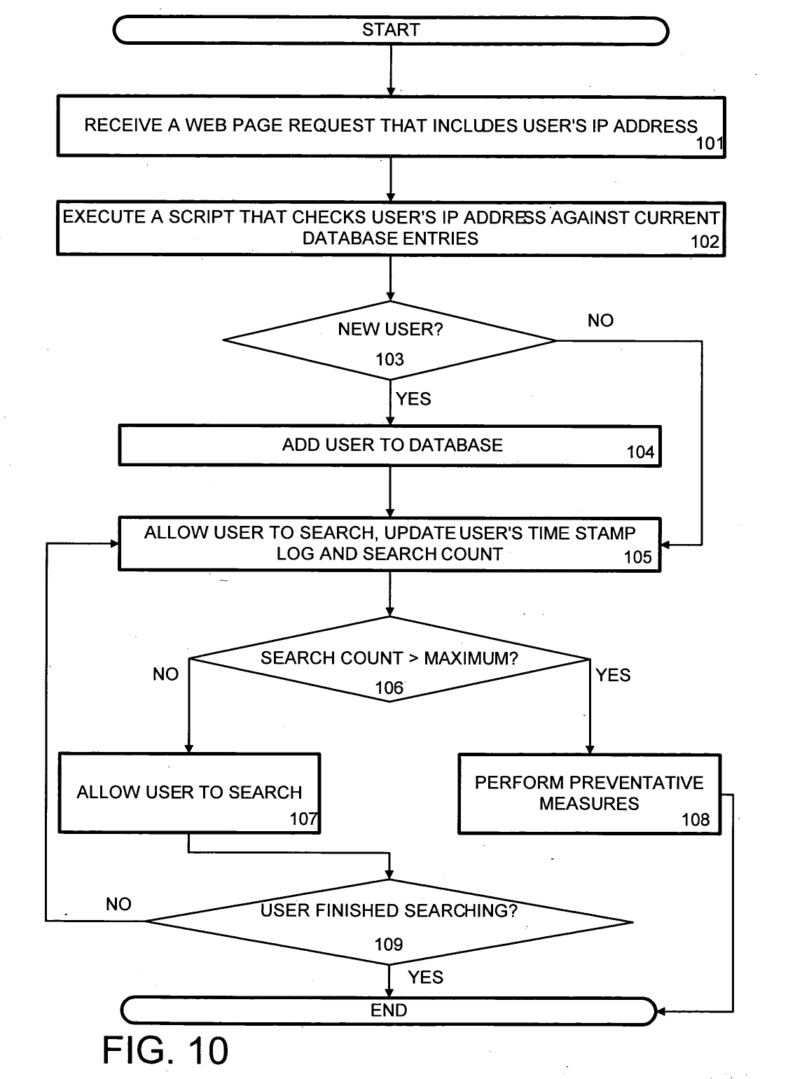

FIG. 10 is a flowchart of a data protection technique for counting user searches on the website of FIG. 2. As illustrated in FIG. 10, the first step is to receive a web page request that includes a user's IP address (step 101). When accessing the Internet, each user is assigned an IP address. This IP address is generally unique for each user on the Internet at a given time. The IP address may be used to identify a user accessing a website. Alternatively, the host network 20 could also assign each user an indicator, such as a caller record, which signifies each user on the website at any given time. Since the caller record is assigned by the host network, the host network can determine parameters of this indicator.

The next step of FIG. 10 is to execute a script (or other process) that checks the user's IP address against current database entries (step 102). Referring to FIG. 1, database entries may be stored in the application database 16, for access by the application servers 18a, 18b. The next step in the flowchart of FIG. 10 is to execute a script (or a second portion of the same script) that determines whether the user is new to the website (step 103). Database entries may include any of a plurality of information including but not limited to an IP address, a time stamp log, and a search count. The time stamp log indicates the last time the user performed a search on the website. The search count is a running total of the total number of searches on the website over a given period of time. As a nonlimiting example, the website may be configured to allow searching as long as a user does not perform more than sixty searches per hour. In such a scenario, the search count will only count the number of searches performed in the last hour.

If the user is new to the website, the user's information will be added to the database (step 104). If the user is not new to the website, the flowchart will bypass step 104, and update the user's time stamp log and search count (step 105) in the database. The user may search for data on the website, and the user's time stamp and search count can be updated (step 105). The website (or host network 20 from FIG. 1) can determine whether the search count exceeds the maximum number of searches over the predetermined period of time. If the user has exceeded the maximum number of searches, the host network 20 may perform preventative measures, such as those discussed with respect to FIGS. 8A, 8B. If the user has not exceeded this maximum, the user may continue searching (step 107). If the user has not fished searching, he or she can return to step 105 to update the time stamp log and search count, and begin another search.

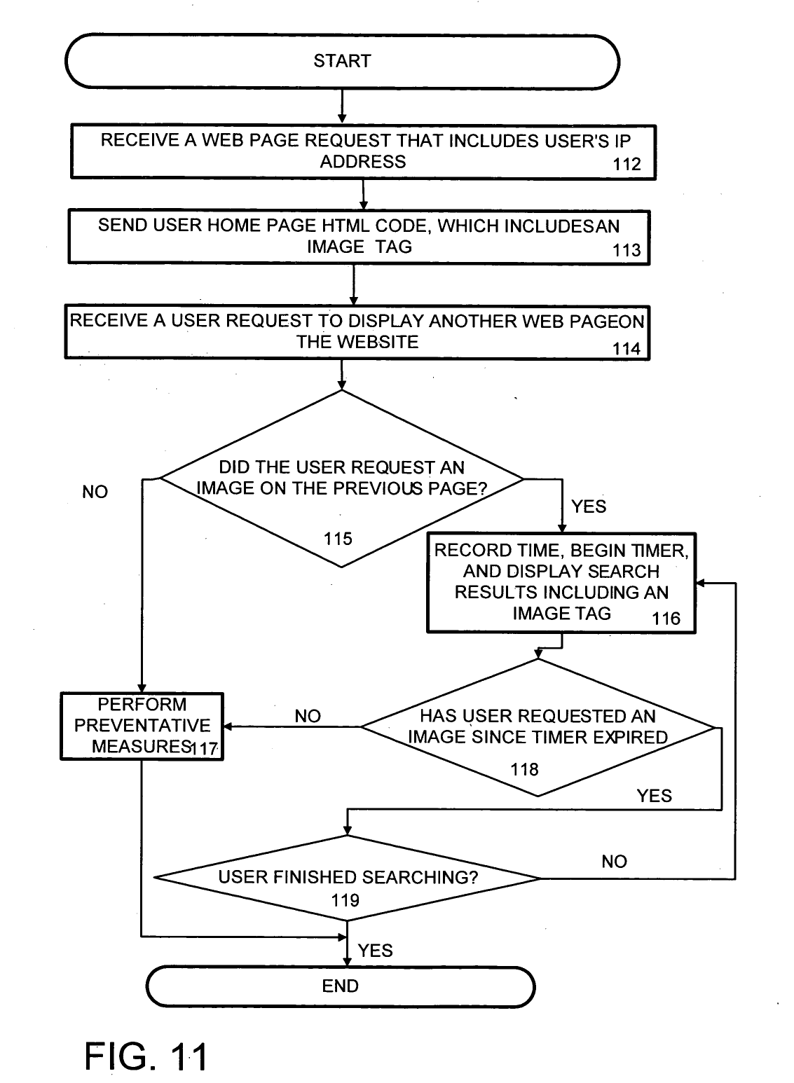

FIG. 11 is a flowchart illustrating alternate steps that can be taken for data protection on the website of FIG. 2. Similar to FIG. 10, the flowchart of FIG. 11 begins by receiving a web page request that includes a user's IP address (step 112). The host network 20 sends to the user home page HTML code, which includes an image tag (step 113). The host network 20 receives a user request to display another web page on the website (step 114). Then the host network 20 determines whether the user requested an image on the previous page (step 115). In at least one embodiment, data related to whether the user accessed an image on a web page is stored in the application database 16. In determining whether an image was requested on the previous page, the system can refer to the application database 16 for the desired information.

If the user did not request an image on the previous page, preventative measures are taken, as discussed above (step 117). If on the other hand, the user did request an image on the previous page, the user is allowed to continue. The host network 20 also records the time of the search, and begins a timer (step 116). Once the timer has expired, the system determines whether the user requested an image from any of the web pages viewed (step 118). If the user has not requested images for any of the web pages, the host network 20 may conclude that the user is a data miner and perform preventative measures as discussed above (step 117). If the user has requested an image in the allotted time, the host network 20 will, determine whether the user is finished searching (step 119), and if not, displays the search results, including an image tag (step 116).

One should note that other sources of information are also included in the scope of this disclosure, including those that do not provide a search interface. More generally, it should be emphasized that many variations and modifications may be made to the above-described embodiments. All such modifications and variations are intended to be included herein within the scope of this disclosure and protected by the following claims.

Therefore, at least the following is claimed:

1. A system for granting access to data on a website, comprising:
a database; and
a server coupled to the database, the server including:
first logic configured to:
receive first data, at least a portion of the first data relating to information about a user machine; and
effect communication of second data, at least a portion of the second data relating to a first web page on a website; and
second logic configured to:
receive third data, at least a portion of the third data relating to whether the user machine requested an image on the first web page;
determine whether the user machine requested an image on the first page; and
perform at least one preventative measure in response to determining that the user did not request an image on the first page.

2. The system of claim 1, further comprising a web server.

3. The system of claim 1, further comprising an application server.

4. The system of claim 1, further comprising a load balancer.

5. The system of claim 1, wherein the preventative measure includes at least one of the following: communicating a second web page that includes only at least one image and preventing the user from future access to the website.

6. The system of claim 1, wherein the second logic is further configured to determine whether the user machine requested an image during a predetermined time period.

7. The system of claim 6, wherein the second logic is further configured perform preventative measures in response to determining that the user machine did not request an image during the predetermined period of time.

8. A method for granting access to data on a website, comprising:
receiving first data, at least a portion of the first data relating to information about a user machine;
effecting communication of second data, at least a portion of the second data relating to a first web page on a website, the first web page including an image;
receiving third data, at least a portion of the third data relating to whether the user machine requested an image on the first web page;
determining from the third data whether the user machine requested an image on the first web page; and
performing at least one preventative measure in response to determining that the user machine did not request an image on the first web page.

9. The method of claim 8, further comprising:
determining that the user machine requested an image on the first web page; and
communicating fourth data, at least a portion of the fourth data relating to a second web page on the website, the second web page including search information.

10. The method of claim 9, further comprising:
determining whether the user machine requested an image over a predetermined period of time; and
performing at least one preventative measure in response to determining that the user did not request an image over the predetermined period of time.

11. The method of claim 8, wherein the preventative measure includes at least one of the following: communicating a second web page in a manner that the search information is displayed as at least one image and preventing the user from future access to the website.

12. The method of claim 8, wherein the first data includes at least one of the following: an Internet Protocol (IP) address and a caller identification.

13. The method of claim 8, wherein the second data includes HyperText Markup Language (HTML) code, the HTML code including an image tag.

14. The method of claim 8, further comprising accessing a database to compare the first data with second data, the second data being stored in the database.

15. A computer readable medium for granting access to data on a website, comprising:
first logic configured for instructing a programmable device to receive first data, at least a portion of the first data relating to information about a user machine;
second logic configured for instructing a programmable device to communicate second data, at least a portion of the second data relating to a first web page on a website, the first web page including an image;
third logic configured for instructing a programmable device to receive third data, at least a portion of the third data relating to whether the user machine requested an image on the first web page;
fourth logic configured for instructing a programmable device to determine from the third data whether the user machine requested an image on the first web page;and
fifth logic configured for instructing a programmable device to perform at least one preventative measure in response to determining that the user machine did not request an image on the first web page.

16. The computer readable medium of claim 15, further comprising
sixth logic configured for instructing a programmable device to determine that the user machine requested an image on the first web page; and
seventh logic configured for instructing a programmable device to communicate fourth data, at least a portion of the fourth data relating to a second web page on the website, the second web page including search information.

17. The computer readable medium of claim 15, further comprising:
eighth logic configured for instructing a programmable device to determine whether the user machine requested an image over a predetermined period of time; and
ninth logic configured for instructing a programmable device to perform at least one preventative measure in response to determining that the user did not request an image over the predetermined period of time.

18. The computer readable medium of claim 15, wherein the preventative measure includes at least one of the following: communicating a second web page in a manner that web page information is displayed as at least one image and preventing the user from future access to the website.

19. The computer readable medium of claim 15, wherein the second data includes HyperText Markup Language (HTML) code, the HTML code including an image tag.

20. The computer readable medium of claim 15, further comprising tenth logic configured for instructing a programmable device to access a database for comparing the first data with second data, the second data being stored in the database.
